(19) United States
(12) Patent Application Publication
(10) Pub. No.: US 2021/0140054 A1
(43) Pub. Date: May 13, 2021

(54) METHODS AND SYSTEMS FOR THE GENERATION OF HIGH PURITY HYDROGEN WITH CO2 CAPTURE FROM BIOMASS AND BIOGENIC WASTES

(71) Applicant: THE TRUSTEES OF COLUMBIA UNIVERSITY IN THE CITY NEW YORK, New York, NY (US)

(72) Inventors: Ah-Hyung Alissa PARK, New York, NY (US); Woojae KIM, Seoul (KR)

(73) Assignee: THE TRUSTEES OF COLUMBIA UNIVERSITY IN THE CITY OF NEW YORK, New York, NY (US)

(21) Appl. No.: 17/155,879

(22) Filed: Jan. 22, 2021

Related U.S. Application Data
(63) Continuation of application No. PCT/US2019/042943, filed on Jul. 23, 2019.
(60) Provisional application No. 62/701,884, filed on Jul. 23, 2018.

(51) Int. Cl. C25B 1/02; B01J 23/755; B01J 35/10

(52) U.S. Cl. CPC C25B 1/02; B01J 35/1014; B01J 23/755

(57) ABSTRACT

A system for producing hydrogen gas from biomass is disclosed that includes a first reaction chamber having one or more hydroxides, a Ni/ZrO₂ catalyst, and a source of moistened seaweed biomass therein. A heat source is in communication with the first reaction chamber. One or more product streams exit the first reaction chamber including, hydrogen gas, a carbonate, or combinations thereof. A recycle stream provides recycled hydroxide to the first reaction chamber and the product stream is produced as a result of reaction of the seaweed biomass source with the one or more hydroxides in the presence of the Ni/ZrO₂ catalyst.

### CROSS REFERENCE TO RELATED APPLICATION

This application is a continuation of International Patent Application No. PCT/US2019/042943, filed Jul. 23, 2019, which claims the benefit of U.S. Provisional Application No. 62/701,884, filed on Jul. 23, 2018, which are incorporated by reference as if disclosed herein in their entirety.

### STATEMENT REGARDING FEDERALLY SPONSORED RESEARCH OR DEVELOPMENT

This invention was made with government support under grant no. CBET1336567 awarded by the National Science Foundation. The government has certain rights in the invention.

### BACKGROUND

Fossil fuel (coal, petroleum and natural gas) plays a dominant role in modern primary energy consumption, and suffers from low utilization efficiency and high pollution. With the development of the global economy and population, the International Energy Agency (“LEA”) has projected that the world's energy demand will increase by 30% by 2040 under their “new policies” scenario. Despite the recent flattening, global CO₂ emissions from energy use are expected to be 35.7 gigatonnes per year under the new policies, which is far from satisfactory for avoiding severe climate change. Increased global energy demand and climate change push for efforts to develop low-carbon and carbon-neutral energy sources. Therefore, renewable low-carbon and carbon-neutral energy sources (solar photovoltaic, biomass, wind, hydropower, etc.) are desperately needed.

Biomass is a potential renewable resource as it can absorb CO₂ and store solar energy through photosynthesis, which means it is a carbon-neutral source and can even be carbon-negative when combined with carbon capture and storage (“CCS”). Biomass is receiving more attention and is expected to replace more than 30% of the U.S. petroleum consumption by 2030, as referenced by the 2011 U.S. Billion-Ton Update. According to the U.S. Energy Information Administration (“HA”), biomass fuels contributed 5% of U.S. primary energy supply in 2016, of which 48% was from biofuels (mainly ethanol), 41% was from wood and wood-derived biomass, and 11% was from the biomass in municipal waste. It is an alternative feedstock to fossil fuel while the land biomass, as the most utilized bioenergy, also has the issues of limited land availability and low growth rate regarding steady supply.

An increased global energy demand and climate change underscore the need for low-carbon and carbon-neutral energy sources. Confronted with the increasing global energy demand and climate change, there has been significant effort to develop low-carbon and carbon-neutral energy sources. Thus, the role of biomass as a sustainable energy source has been further emphasized and various biomass conversion technologies have been developed including pyrolysis and gasification.

Hydrogen fuel provides a viable energy source and can be extracted from biomass by pyrolysis or gasification, thermal conversion approaches of converting biomass into sustainable energies without the use of combustion. However, current gasification methods often generate carbon gases as byproducts. As such, there is a need for a method to convert biomass to hydrogen fuel that reduces and/or captures carbon gases. However, conventional gasification and pyrolysis technologies require high temperatures (700-1000° C.) for effective hydrogen gas production.

Among thermal conversion approaches, the Alkaline Thermal Treatment (“ATT”) of biomass provides a pathway that produces high purity H₂ with substantially suppressed CO₂ formation. Examples of these ATT methods can be found in U.S. Pat. No. 9,862,610, which is incorporated herein by reference in its entirety. Thus, there is a potential for not only carbon-neutrality but also carbon-negativity by integrating carbon capture and storage: bioenergy with carbon capture and storage (“BECCS”).

Seaweed is one source of aquatic biomass. It is available worldwide and used as human foods, cosmetics, fertilizers and chemical feedstock. Compared to terrestrial biomass, seaweed has a high average CO₂ sequestration (36.7 t hectare⁻¹ year seven times that of conventional lignocellulosic biomass), fast growth rate (harvested up to six times a year), no need of fertilizer, and no competition with land-based food crops.

A variety of hydrogen production methods from seaweed are available, which can be divided into two major categories, thermochemical and biological processes. Thermochemical technology mainly includes gasification and pyrolysis while biological processes basically involve anaerobic digestion and bio-photolysis. Thermochemical processes are much faster and are more energy intensive while biological ones provide simultaneous waste recycling and hydrogen generation but have low hydrogen production rates and require large scale tank reactors. The production cost is in the range of 1.25-2.20 $/kg H₂ in biomass pyrolysis and gasification and around 2 $/kg H₂ in the biological processes due to their low rates and high investment cost. It is expected that the thermochemical pyrolysis and gasification have the potential to produce H₂ on a large scale in the near future. However, the conventional gasification and pyrolysis methods need a dry feedstock while the high-moisture content (80-90%) of seaweed requires a drying prior to energy conversion. Though the recent supercritical water gasification can tolerate wet seaweed, the enormous energy consumption and salt precipitation limit its application. Meanwhile, seaweed has a high ash content with large amount of alkali and alkaline earth species, which can promote the surface carbon active site, reduce tar production, and decrease the char formation.

### SUMMARY

According to a first embodiment of the present disclosure, a carbon-neutral method for cleanly extracting hydrogen gas from biomass is disclosed herein. In some embodiments, this technology combines alkaline thermal treatment (“ATT”) with nickel catalysts to provide high purity hydrogen fuel. In some embodiments, the method reacts carbon gases, e.g., carbon dioxide, from gasification with hydroxide, which allows for the capture and storage of the gas. As a result, some embodiments of the systems and methods of the present disclosure produce hydrogen gas sufficient to replace known gasification technologies.

Some embodiments of this technology can extract hydrogen from a number of different types of biomass, including salty, wet biomass such as seaweed, lignin, cellulose, hemicellulose, and wheat straw grass.

In some embodiments, systems and methods of the present disclosure are directed to the conversion of seaweed to H₂ by reacting it with an alkaline hydroxide, e.g., NaOH, in the presence of a catalyst, e.g., 10% Ni/ZrO₂ catalyst. In some embodiments, a multi-zone split-tube furnace is used to create different reaction zones. In some embodiments, this includes three zones, for in-situ (i.e., solid and gas phase) and ex-situ (i.e., gas phase only) catalytic ATT reaction schemes.

In some embodiments, ATT can utilize wet and salty biomass such as seaweed. Some embodiments of the present technology result in (1) the conversion of wet biomass (e.g., seaweed) to high purity H₂ with suppressed CO and CO₂ generation by reacting it with hydroxide (e.g., NaOH) in the presence of Ni catalyst (e.g., 10% Ni/ZrO₂ catalyst) and (2) additional hydroxide for complete CO₂ capture.

### BRIEF DESCRIPTION OF THE DRAWINGS

The drawings show embodiments of the disclosed subject matter for the purpose of illustrating the technology. However, it should be understood that the present application is not limited to the precise arrangements and instrumentalities shown in the drawings, wherein:

FIG. 1 is a diagram of an system for hydrogen production from biomass according to some embodiments of the present disclosure;

FIG. 2 is a chart of a method for hydrogen production from biomass according to some embodiments of the present disclosure;

FIG. 3 is a bar graph comparing conventional biomass gasification and embodiments of the present disclosure;

FIG. 4 is a bar graph depicting biomass gasification including the ATT reaction of hemicellulose (xylan) with a nickel catalyst according to some embodiments of the present disclosure;

FIG. 5 is a bar graph comparing simple steam gasification and an alkaline thermal treatment according to some embodiments of the present disclosure;

FIG. 6 depicts the Ni/ZrO₂ and Ca(OH)₂ performance before and after the ATT reaction according to some embodiments of the present disclosure;

FIG. 7 depicts a line graph of specific gas phase measurements performed according to some embodiments of the present disclosure;

FIG. 8 depicts a line graph of additional specific gas phase measurements performed according to some embodiments of the present disclosure;

FIG. 9 is a bar graph depicting the hydrogen production with each bar including phase information;

FIG. 10A depicts the H₂ production per gram of dry seaweed of an ATT reaction according to some embodiments of the present disclosure compared with the previous seaweed gasification;

FIG. 10B depicts the H₂ production per gram of seaweed of an ATT reaction according to some embodiments of the present disclosure compared with the previous seaweed gasification;

FIG. 10C depicts the H₂ production per gram of dry seaweed of an ATT reaction according to some embodiments of the present disclosure compared with the previous seaweed gasification at specific pressures; and

FIG. 11 depicts thermogravimetric plots showing mass loss for brown seaweed.

### DETAILED DESCRIPTION

Referring now to FIG. 1, in some embodiments, the present disclosure is directed to an approach for hydrogen production from biomass, e.g., seaweed. In some embodiments, a reaction medium including a moistened seaweed biomass, one or more hydroxides, and a catalyst is provided. In some embodiments, the biomass is reacted with one or more alkaline reactants in the presence of a catalyst. In some embodiments, the alkaline reactant is an alkaline hydroxide. In some embodiments, the alkaline hydroxide is sodium hydroxide, potassium hydroxide, calcium hydroxide, etc., or combinations thereof. In some embodiments, the catalyst is a nickel catalyst. In some embodiments, the catalyst is Ni/ZrO₂.

In some embodiments, the present disclosure is directed to a system 100 for facilitating the production of hydrogen from biomass. In some embodiments, system 100 includes at least a first reaction chamber 102 including a reaction medium 102A. As discussed above, in some embodiments, reaction medium 102A includes one or more hydroxides and a source of seaweed biomass. In some embodiments, the one or more hydroxides includes sodium hydroxide, potassium hydroxide, calcium hydroxide, or combinations thereof. In some embodiments, the one or more hydroxides includes sodium hydroxide. In some embodiments, the seaweed biomass is pretreated before use in reaction medium 102A. In some embodiments, the seaweed biomass is not pretreated before use in reaction medium 102A, i.e., freshly harvested seaweed biomass is used in system 100. In some embodiments, seaweed biomass includes at least some moisture, i.e., moistened. In some embodiments, the moisture content of the seaweed biomass is above about 50%, above about 60%, above about 70%, or above about 80%. In some embodiments, reaction medium 102A includes a nickel catalyst. In some embodiments, reaction medium 102A includes an additional hydroxide. In some embodiments, system 100 includes at least one additional reaction chamber 103 in fluid communication with first reaction chamber 102. In some embodiments, additional reaction chamber 103 includes additional reaction components 103A. In some embodiments, additional reaction components 103A include a nickel catalyst. In some embodiments, additional reaction components 103A include an additional hydroxide. In some embodiments, the additional hydroxide includes sodium hydroxide, potassium hydroxide, calcium hydroxide, or combinations thereof. In some embodiments, a heat source 104 is in communication with first reaction chamber 102, e.g., to facilitate heating of reaction medium 102A disposed therein, additional reaction chamber 103, or combinations thereof. In some embodiments, system 100 includes one or more product streams 106, e.g., exiting first reaction chamber 102, additional reaction chamber 103, or combinations thereof. In some embodiments, the one or more product streams 106 are produced as a result of reaction of the seaweed biomass source with the one or more hydroxides in the presence of the nickel catalyst. In some embodiments, product streams 106 include hydrogen gas product streams, carbonate product streams, or combinations thereof. In some embodiments, a recycle stream 108 is provided for recycling hydroxide to the first reaction chamber, e.g., from a carbonate product stream. In some embodiments, the nickel catalyst is also recycled.

In some embodiments, the system includes a first reaction chamber having therein one or more hydroxides, a Ni/ZrO₂ catalyst, and a source of moistened seaweed biomass. In other embodiments, the system includes at least two reaction chambers. In some embodiments, the system includes at least one additional reaction chamber in fluid communication with the first reaction chamber, and the additional reaction chamber has an additional alkaline reactant therein. In some embodiments, the additional alkaline reactant is a different alkaline hydroxide than the first hydroxide. In some embodiments, the one or more hydroxides includes sodium hydroxide, potassium hydroxide, calcium hydroxide, or combinations thereof. In some embodiments, the system includes a heat source in communication with the first reaction chamber. In some embodiments, the system includes one or more product streams exiting the first reaction chamber including hydrogen gas, a carbonate, or combinations thereof. In some embodiments, the system includes a recycle stream for providing recycled hydroxide to the first reaction chamber. In some embodiments, the product stream is produced as a result of reaction of the seaweed biomass source with the one or more hydroxides in the presence of the Ni/ZrO₂ catalyst

In an exemplary embodiment, a horizontal three-zone split-tube furnace is used to create different reaction zones for in-situ (i.e., solid and gas phase) and ex-situ (i.e., gas phase only) catalytic ATT reaction schemes. In some embodiments, a first alkaline reactant, e.g., alkaline hydroxide, is positioned in a first reaction chamber. In some embodiments, an additional alkaline reactant, e.g., a different alkaline hydroxide, is position in a second and/or subsequent reaction chamber. In some such embodiments, reaction products such as CO₂ gas that are evolved in zone 1 as a result of the ATT reaction are subsequently sequestered via reaction with the second alkaline reactant. In some embodiments, the second reaction chamber includes a catalyst.

In some embodiments, a thermal treatment of reaction medium, e.g., 102A, is performed at a temperature between about 400° C. and about 600° C. to produce a hydrogen product and a carbonate product. In some embodiments, the reaction is performed at a temperature below 700° C. In some embodiments, the reaction is performed at a temperature between about 400° C. and about 600° C. In some embodiments, the reaction is performed at about 500° C. In some embodiments, the reaction is performed at a low pressure. In some embodiments, the reaction is performed at a pressure below supercritical pressure. In some embodiments, the reaction is performed at about atmospheric pressure. In some embodiments, the reaction products include hydrogen. In some embodiments, the reaction products include a carbonate. In some embodiments, the carbonate product is recycled as a recycled hydroxide. In some embodiments, the carbonate is recycled to regenerate and replenish alkaline reactant. In some embodiments, the hydrogen product is suitable for a variety of uses, such as a fuel, e.g., in a fuel cell, for combustion, for use in synthesis of other compounds, e.g., ammonia, methanol, etc. In some embodiments, the reaction products include one or more hydrocarbons, such as CO₂, for sequestering, e.g., in at least a second hydroxide.

In some embodiments, the reaction between the biomass, alkaline reactant, and catalyst includes additional reactants, e.g., water, carbon dioxide, one or more additional catalysts, one or more additional hydroxides, etc. In some embodiments, the catalyst is subsequently recycled, e.g., for reuse in reaction with biomass to produce additional hydrogen. In some embodiments, the alkaline reactant is replenished via a subsequent recycling step, and the replenished alkaline reactant is reused, e.g., in reactions with additional biomass to produce additional hydrogen. For example, sodium carbonate product can be recycled to replenish a supply of sodium hydroxide reactant utilizing the following reaction scheme:

Na₂CO₃+Ca(OH)₂=CaCO₃+NaOH

In some embodiments, one or more additional hydroxides are used to sequester hydrocarbon product in a subsequent reaction step. In some embodiments, one or more additional catalysts are included to aid in the sequestration of the hydrocarbon product.

In some embodiments, wet seaweed is directly coverted to high-purity H₂ with suppressed CO₂ formation at atmospheric pressure and relatively low temperature with the yield of up to 75.82 mmol H₂/g-seaweed(daf). Some embodiments are simple, renewable, less energy intensive and address issues related to hydrogen production. Some embodiments convert substantially all biomass to H₂ even at much lower temperature ranges (e.g. 500° C.) than conventional biomass gasification/pyrolysis (e.g., 700˜1000° C.), via the described reaction pathway. Some embodiments of the current method generate hydrogen in high yield (highest value among all reported seaweed gasification technology to date) and some embodiments do not produce CO/CO₂, indicating that the product gas is clean fuel, which can be directly used as, for example, a fuel for fuel cell cars without any additional treatment. The strategy with chemical looping illustrated in FIG. 1 at least suggests its feasibility in the future.

Although the present disclosure details the production of hydrogen from seaweed, the present disclosure is not limited in this regard, as this method can be applied to all types of biomass, including, brown seaweed, green seaweed, red seaweed, lignin, cellulose, hemicellulose, wheat straw grass, glucose, etc., or combinations thereof. In some embodiments, the biomass includes a salt component. In some embodiments, the biomass has a naturally occurring level of salinity. In some embodiments, the biomass has an elevated level of salinity relative to a naturally occurring level of salinity.

Referring now to FIG. 2, some embodiments of the present disclosure are directed to a method 200 of producing hydrogen gas from biomass. In some embodiments, at 202, a reaction medium is provided. As discussed above, in some embodiments, the reaction medium includes a moistened seaweed biomass and one or more hydroxides. In some embodiments, the reaction medium includes a nickel catalyst. At 204, thermal treatment, e.g., heating, of the reaction medium is performed. In some embodiments, the reaction medium is heated to a temperature between about 400° C. and about 600° C. to produce a hydrogen product and a carbonate product. In some embodiments, the reaction medium is heated to a temperature of about 500° C. In some embodiments, thermal treatment 204 is performed below supercritical pressure. In some embodiments, thermal treatment 204 is performed at about atmospheric pressure. In some embodiments, at 206, the carbonate product is recycled as a recycled hydroxide, e.g., for reuse in thermal treatment 204. In some embodiments, at 208, carbon dioxide formed during thermal treatment 204 of the reaction medium is sequestered in at least a second hydroxide.

### EXAMPLES

The brown seaweed in a first example had a high ash content and low moisture content. Therefore, dry ash-free basis was used to compare with existing studies. The brown seaweed has a larger amount of alkali and alkaline earth species (K, Na, Ca, etc.), which can enhance the gasification activity of carbon in carbonaceous materials. K and Ca can have a significant impact on the surface active site formations in the carbon gasification. They can also reduce tar formation, catalyze tar decomposition and hinder the char formation.

TABLE 1
Composition of Brown Seaweed

| Components | Saccharina japonica (Brown seaweed) |
|---|---|
| Gravitation analysis | |
| Moisture (wt %) | 7.8 |
| Total solid, TS (wt %) | 92.2 |
| Ash (wt % in TS) | 28.3 |
| VS (wt % in TS) | 71.7 |
| Elemental analysis | |
| C (wt % in TS) | 31.5 |
| H (wt % in TS) | 4.8 |
| O (wt % in TS) | 26.1 |
| N (wt % in TS) | 1.5 |
| S (wt % in TS) | 0.6 |
| Total COD (mg/g TS) | 829.7 |

TABLE 2
Ash Composition of Brown Seaweed

| | Content (wt % of ash) |
|---|---|
| Component | Brown seaweed |
| SiO₂ | 0.66 |
| Al₂O₃ | 0.25 |
| Fe₂O₃ | 0.08 |
| MgO | 7.70 |
| CaO | 7.95 |
| Na₂O | 26.16 |
| K₂O | 53.97 |
| TiO₂ | n.d. |
| P₂O₅ | 3.23 |
| MnO | n.d. |
| Cr₂O₃ | n.d. |
| V₂O₅ | n.d. |

n.d. = not detected

Referring now to FIG. 3, a comparison between conventional biomass gasification and some embodiments of the present disclosure is portrayed. Almost no hydrogen can be formed from conventional seaweed biomass gasification at the low temperature (e.g., 500° C.) and pressure of the present disclosure as can be seen at the leftmost set of bars on the graph (Brown seaweed). When hydroxide reactant (e.g., NaOH) is mixed with seaweed for ATT, then hydrogen is produced even at this low temperature (Brown seaweed+NaOH), shown in the center set of bars. Even more hydrogen is generated by addition of Ni catalyst (Brown seaweed+NaOH+Catalyst) shown on the rightmost set of bars. This result (amount of hydrogen generated per g biomass used) is promising as compared to reported seaweed gasification technologies.

Referring now to FIG. 4, these results show the ATT reaction of hemicellulose (xylan) with Ni catalyst for hydrogen production and additional capture of CO2. As can be seen in all sets of bars shown in the graph, very clean hydrogen is produced in large amount with this ATT method. In some embodiments, it is believed that Ni catalyst helps produce hydrogen, but also generates CO₂ during steam methane reforming (Xylan+NaOH+Ni catalyst bar graph). Including additional hydroxide reactants (e.g., Ca(OH)₂) with Ni catalyst, nearly all CO₂ is captured (Xylan+NaOH+Ni Cat+2nd hydroxide (1st run) bar graph). This hydroxide can be reused for several runs for CO₂ capture, and/or can be easily replaced for further runs.

Referring now to FIG. 5, again, simple steam gasification gives very low H₂, high CO₂ and many C₂ gases. However, the alkaline thermal treatment significantly changes this phenomenon. In this embodiment, it greatly enhances the H₂ formation and decomposes the C₂ hydrocarbon. NaOH can capture CO₂ and decompose the seaweed into relevant intermediates to increase the gas yields. In some embodiments, adding water to make a wet seaweed does not make a big difference, which means the ATT reaction can directly take use of the wet feedstock and do the conversion. Moreover, the Ni catalyst has a good activity in reforming CH₄ to H₂ in some embodiments, but generates some CO₂ while Ca(OH)₂ can absorb the produced CO₂. The H₂ yield can reach up to 75.82 mmol/g-seaweed(daf) integrated with CO₂ capture.

Referring to Table 3, simple gasification has a low carbon conversion of 12.48% while the ATT reaction greatly promotes the carbon conversion to inorganic carbon, primarily carbonate. The catalyst and Ca(OH)₂ in zone 2 do not affect the reaction of seaweed and NaOH that much thus to make the gas reforming and CO₂ capture be implemented. The ATT reaction performs well in seaweed conversion and is a promising method for the future.

TABLE 3
Carbon Analysis

| | Inorganic | Total | |
|---|---|---|---|
| | carbon | carbon | Inorganic/Total |
| Sample | (wt. %) | (wt. %) | (wt. %) |
| Brown seaweed (zone 1) | 4.1347 | 33.1152 | 12.4858 |
| BS + NaOH (zone 1) | 8.2763 | 9.2086 | 89.8758 |
| BS + NaOH + water | 8.3202 | 9.1473 | 90.9560 |
| (zone 1) | | | |
| BS + NaOH | 7.4192 | 8.1648 | 90.8681 |
| (zone 1)_catalyst (zone 2) | | | |
| BS+NaOH | | | |
| (zone 1)_catalyst + Ca(OH)₂ | | | |
| (zone 2) | | | |

Referring now to FIG. 6, EDS was adopted to observe the element variations before and after ATT reaction in some embodiments. The element compositions of the catalyst do not change significantly after ATT reaction, basically the O, Ni and Zr, which indicates the catalyst property as a Ni/ZrO₂. Also, it shows the Ni/ZrO₂ catalyst does not have many carbon deposits and can be reused. However, the spectrums of C and O elements in Ca(OH)₂ have some enhancement, indicating the generation of CaCO₃. This is consistent with the overall ATT reaction and also verified by the results of carbon analysis.

Referring now to FIG. 7, gas phase measurements were performed to further analyze the reaction mechanism. It can be seen that the H₂ peak, CH₄ peak and CO₂ peak are in the same temperature range, which means the increases of H₂ and CO₂ accompanied by the decrease of CH₄. In some embodiments, the nickel catalyst has a good activity in steam methane reforming (CH₄+H₂O→CO+3H₂) and water gas shift (CO+H₂O→CO₂+H₂). Thus, 1 mol CH₄ generates 1 mol CO and 3 mol H₂ via SMR reaction while 1 mol CO generates 1 mol H₂ via WGS reaction, i.e., 1 mol CH₄ can produce 4 mol H₂.

Referring now to FIG. 8, the H₂ formation continues with the CH₄ reforming and CO₂ capture. The catalyst works via WGS and SMR and is not hindered by Ca(OH)₂. In some embodiments, the Ca(OH)₂ absorbs the CO₂ (CO₂+Ca(OH)₂→CaCO₃) and has no great effect on the ATT reaction, resulting in high-purity H₂ combined with CO₂ capture in the present disclosure.

Referring now to FIG. 9, by investigating the gas phase and solid phase mechanisms, a general understanding in the ATT reaction in some embodiments can be obtained. For the H₂ formation, it can be responsible for many secondary reactions. The steam gasification of brown seaweed produces very limited H₂ while the NaOH promotes the conversion to 35.69 mmol H₂/g-seaweed (daf). Meanwhile, adding water to make a wet seaweed of 90% moisture does not appear to make a change in the H₂ formation, which demonstrates the feasibility in the direct use of wet feedstock in ATT reaction. The Ni catalyst helps the CH₄ reforming to H₂ and CO shift to H₂ via SMR and WGS process. These make a great contribution to the H₂ production. Moreover, other reactions such as tar decomposition and steam tar reforming also increase the H₂ production. With all the efforts of these reactions, the H₂ production of 75.82 mmol/g-seaweed(daf) can be accomplished.

### Methods

Reagents. The Saccharina japonica, brown seaweed (BS) was obtained from Korea and was grinded to <150 um. The NaOH and Ca(OH)₂ were obtained from Sigma-Aldrich and used without further purification. The Ni-catalyst was prepared by dissolving 2.7526 g of nickel(II) nitrate hexahydrate into 80 mL of ethanol and then 5 g of finely ground ZrO2 (Alfa Aesar) was added to the solution. The mixture was stirred and heated to gradually impregnate the metal salt into the support. The catalyst was then dried at 363 K overnight and calcined in air at a heating rate of 5 K min⁻¹ to 1073 K and holding for 200 min. The oxidized metals were then reduced in a tube furnace in a pure H₂ atmosphere for 2 hours at 773 K. The 10% Ni/ZrO₂ had a specific surface area of 23.246 m² g⁻¹ and an average particle size of 35.96 nm.

Reactor set-up. The tubular reactor consists of an inner quart tube (2.54 cm Outer Diameter×56.00 cm length) and outer three-zone split-tube furnace (Mellen Co., SC12R). The brown seaweed sample mixed with NaOH in a ceramic boat was placed in zone 1 and a thermocouple was used to monitor the temperature in the alkaline thermal treatment (ATT) experiments. The catalyst (if used) and Ca(OH)₂ (if used) were separately held in three pieces of quartz wool in zone 2 to make the reforming of gaseous intermediates and CO₂ capture. A Micro GC (Inficon 3000) was used to sample the gaseous products online throughout and the gasbag was adopted to obtain the total gas yield.

ATT experiments. The current research included probing the fate of salt and the regeneration of hydroxide from the seaweed ATT process.

1.0 g of mixed samples (the molar ratio of brown seaweed and NaOH was based on the reaction stoichiometry and all the results were normalized to the dry ash-free grams of seaweed to enable accurate comparisons) was added to a 10 ml ceramic boat, which was lying in zone 1 of the reactor. 0.25 g of 10% Ni/ZrO₂ catalyst and 0.75 g of Ca(OH)₂ were separately placed in zone 2 of the reactor. 50 ml of N₂ carrier gas was introduced through the reactor via a mass flow controller (Omega FMA5508) as a reference gas in the gas chromatography (GC) measurements. After the purging step by N₂, the reactor and the surrounding hotbox were pre-heated at a heating rate of 4 K min⁻¹ to 373 K and held for 30 minutes. After the pre-heating, water was injected into the hotbox via a pump at a rate of 0.023 K min⁻¹, where it was vaporized and carried by N₂ to provide the steam stream. The ATT reaction was then started by heating the reactor at a rate of 4 K min⁻¹ to 773 K and held for 60 minutes. Referring to FIG. 5, the gaseous product exiting the reactor was passed through a condenser 12 to separate the liquid compounds in a liquid collector 14 from light gases in a gasbag 16. The light gases were then analyzed online via a Micro GC 18 with a sampling rate of 2.0 minutes. The overall gas products were collected in a Tedlar® bag.

Gas analysis. Gas chromatography (“GC”) was conducted on an Inficon Micro-GC 3000. It is equipped with two 10 m Molsieve columns for H₂, O₂, N₂, CH₄, and CO analyses, and an 8 m Plot U for CO₂ and C₂H₆ analyses. The detection limits were 20 ppm for H₂, and in the ppm ranges for O₂, N₂, CH₄, CO, and CO₂. N₂ was used as a reference gas to qualify the gas production and all the gas yields were normalized to the moles.

Carbon analysis. The carbon compositions of solid residues after ATT reaction were analyzed by a UIC CM150 Coulometer with Total Carbon and Inorganic Carbon modules. The total carbon was calculated by burning the residues in pure O₂ at 1173 K and testing the released CO₂ while the inorganic carbon was obtained by dissolving the sample in perchloric acid and measuring the released CO₂. The total carbon and inorganic carbon contents then reflected the carbon conversion and the efficiency of these ATT reactions.

The methods and systems of the present disclosure are advantageous for use as biomass conversion mechanism for green energy, an environmentally friendly energy alternative to oil, carbon capture and storage, while reducing CO₂ emissions, generating carbon credits, e.g., with carbon-negative system, for use with many applications, e.g., fuels cells, including all-in-one portable fuel cells, power plants to produce hydrogen-based electricity, etc. In some embodiments, the methods and systems of the present disclosure can be operated at much lower temperatures than conventional pyrolysis/gasification (˜500° C.). In other embodiments, the methods and systems according to the present disclosure can be operated at lower pressures. In some embodiments of this technology all biomass can be converted to hydrogen gas at lower temperatures (500° C.) than conventional biomass gasification processes (700˜1000° C.), reducing the amount of input energy needed. In some embodiments, this technology can be used to extract clean hydrogen fuel from biomass through a carbon-negative process. In some embodiments, this technology combines gasification of biomass with carbon sequestration to produce a pure hydrogen fuel. In some embodiments, this technology has the added benefit of working with lower than conventional temperatures, which can reduce operating and equipment costs.

Referring now to FIG. 10A-10C, an ATT reaction according to one embodiment of the present invention is compared with the previous seaweed gasification. In this embodiment, the ATT reaction can achieve a H₂ production of 75.82 mmol/g-seaweed(daf), considerably higher than other methods. Furthermore, severe operating conditions that are often required in the prior art such as high temperatures or supercritical pressures are avoided in this embodiment. Some embodiments of the present disclosure can be operated at lower temperatures, e.g., 500° C., and pressures, e.g., atmospheric pressure, which lowers energy cost. Additionally, some embodiments of the present disclosure take advantage of wet feedstock without pretreatment while traditional thermochemical methods of seaweed energy extract require dry pretreatment. Therefore, embodiments of the present disclosure have a promising future in the H₂ production.

Referring now to FIG. 11, thermogravimetric plots showing mass loss for brown seaweed are portrayed.

Although the invention has been described and illustrated with respect to exemplary embodiments thereof, it should be understood by those skilled in the art that the foregoing and various other changes, omissions and additions may be made therein and thereto, without parting from the spirit and scope of the present invention.

What is claimed is:

1. A system for producing hydrogen gas from biomass comprising:
a first reaction chamber having therein one or more hydroxides, a nickel catalyst, and a source of moistened seaweed biomass;
a heat source in communication with the first reaction chamber;
one or more product streams exiting the first reaction chamber including hydrogen gas, a carbonate, or combinations thereof; and
a recycle stream for providing recycled hydroxide to the first reaction chamber;
wherein the one or more product streams are produced as a result of reaction of the seaweed biomass source with the one or more hydroxides in the presence of the nickel catalyst.

2. The system according to claim 1, further comprising at least an additional reaction chamber in fluid communication with the first reaction chamber, the additional reaction chamber having an additional hydroxide therein.

3. The system according to claim 1, wherein the one or more hydroxides includes sodium hydroxide, potassium hydroxide, calcium hydroxide, or combinations thereof.

4. The system according to claim 2, wherein the additional hydroxide includes sodium hydroxide, potassium hydroxide, calcium hydroxide, or combinations thereof.

5. The system according to claim 1, wherein the one or more catalysts is Ni/ZrO₂.

6. A method of producing hydrogen gas from biomass comprising:
providing a reaction medium including a moistened seaweed biomass, one or more hydroxides, and a nickel catalyst;
performing a thermal treatment of the reaction medium at a temperature between about 400° C. and about 600° C. to produce a hydrogen product and a carbonate product; and
recycling the carbonate product as a recycled hydroxide.

7. The method according to claim 6, wherein the reaction temperature is about 500° C.

8. The method according to claim 6, wherein the one or more hydroxides is sodium hydroxide, potassium hydroxide, calcium hydroxide, or combinations thereof.

9. The method according to claim 6, further comprising sequestering carbon dioxide formed during thermal treatment of the reaction medium in at least a second hydroxide.

10. The method according to claim 6, wherein the thermal treatment is performed below supercritical pressure.

11. The method according to claim 10, wherein the thermal treatment is performed at about atmospheric pressure.

12. The method according to claim 7, wherein the seaweed biomass includes brown seaweed, green seaweed, red seaweed, or combinations thereof.

13. The method according to claim 8, wherein the one or more catalysts is Ni/ZrO₂.

14. A system for producing hydrogen gas from biomass comprising:
a first reaction chamber including a reaction medium including one or more hydroxides and a source of moistened seaweed biomass;
an additional reaction chamber including a Ni/ZrO₂ catalyst and one or more additional hydroxides,
a heat source in communication with at least the first reaction chamber;
one or more product streams exiting the first reaction chamber including hydrogen gas, a carbonate, or combinations thereof; and
a hydroxide recycle stream in communication with the one or more product streams and the first reaction chamber;
wherein the product stream is produced as a result of reaction of the seaweed biomass source with the one or more hydroxides in the presence of the Ni/ZrO₂ catalyst.

15. The system according to claim 14, wherein the one or more hydroxides includes sodium hydroxide.

16. The system according to claim 14, wherein the hydroxide recycle stream includes one or more hydroxides recycled from a carbonate product stream.

17. The system according to claim 14, wherein the one or more additional hydroxides is sodium hydroxide, potassium hydroxide, calcium hydroxide, or combinations thereof.

18. The system according to claim 14, wherein the seaweed biomass includes brown seaweed, green seaweed, red seaweed, or combinations thereof.

19. The system according to claim 14, wherein the heat source is configured to maintain a reaction temperature between about 400° C. and about 600° C. to produce a hydrogen product and a carbonate product.

20. The system according to claim 14, wherein the reaction temperature is about 500° C.
